(19) United States
(12) Patent Application Publication
(10) Pub. No.: US 2025/0220292 A1
(43) Pub. Date: Jul. 3, 2025

(54) CELL PHONE CASE WITH LENS AND/OR COLOR FILTERS

(71) Applicant: Alan Uke, Coronado, CA (US)

(72) Inventor: Alan Uke, Coronado, CA (US)

(21) Appl. No.: 19/005,763

(22) Filed: Dec. 30, 2024

Related U.S. Application Data
(60) Provisional application No. 63/616,082, filed on Dec. 29, 2023.

(51) Int. Cl. H04N 23/56; H04M 1/02; H04M 1/22

(52) U.S. Cl. CPC H04N 23/56; H04M 1/0203; H04M 1/0264; H04M 1/22; H04M 2250/52

(57) ABSTRACT

Disclosed is a phone case comprising a light switcher configured to move at least one of a lens and a color filter over a light of a cell phone.

### BACKGROUND

### 1. Field

Example embodiments relate to cell phone cases having one or more lenses, color filters, and/or mirrors.

### 2. Description of the Related Art

FIGS. 1A and 1B respectively show a front and back view of a conventional cell phone case 100. As shown in FIGS. 1A and 1B the conventional cell phone case 100 is somewhat rectangular in shape having a substantially continuous and planer front face 105 with a window 150. The cell phone case 100 has a top 110, a bottom 120, a first side 130 and a second side 140. As shown in FIGS. 1C and 1D, the top 110, the bottom 120, the first side 130, and the second side 140 include walls extending from the front face 105 which include lips forming a space 160 into which a cell phone 200 may be captured. In the conventional art, cell phone cases are generally formed from materials such as, but not limited to, plastic, leather, carbon fibers and/or aramid fibers. Thus, most conventional cell phone cases are somewhat resilient allowing a cellphone case to flex and capture the cell phone in the space 160 as shown in FIGS. 2C and 2D.

FIGS. 2A and 2B respectively show a front and back view of the conventional cell phone case 100 with a cell phone 200 captured in space 160. As shown in FIG. 2B the cell phone 200 includes an interface 205, for example, a touchscreen, enabling a user to control various aspects of the cell phone 200. The interface 205 may also present images and videos to a user. As shown in FIG. 2A, the cell phone 200 may further include one or more cameras 210 which may be used to take pictures or videos. The cell phone 200 may also include additional features, for example, a light 220 (which may be a light emitting diode (LED), which may also be considered a flashlight) and a sensor 230, for example, a LiDAR, which may aid in computing a distance from the cameras 210 to an object to be photographed. It is understood the cameras 210, light 220, and LiDAR 230 may be exposed by the window 150. This allows the cameras 210 an unobstructed view of an object to be photographed. It also allows for the LiDAR 230 to function properly while also allowing the light 220 to illuminate the environment. It is understood the cell phone 200 described herein is merely for the purpose of illustration as conventional cell phones vary from one embodiment to another. For example, some cell phones include only a single camera while others have two cameras while others may have more than three cameras. Furthermore, the arrangement of the cameras may vary from one cell phone to another. For example, while the embodiment of FIGS. 2A and 2B shows three cameras 210 forming a triangular pattern it is known that other cell phones arrange the cameras in a single line.

### SUMMARY

The inventor has noticed that while conventional cell phone cases do protect cell phones from damage they do not enhance the usefulness of a cell phone. The inventor therefore sought to modify cell phone cases to enhance the usefulness of a cell phone by presenting lenses and/or color filters to the lights present in the conventional cell phones. Example embodiments also allow for light normally shining out a back of a cell phone to be directed out a front of a cell phone. It is understood that while the inventor set out to improve conventional cell phone cases the inventive concepts are not limited thereto as the inventive concepts described herein may be applied across various industries and technologies.

### BRIEF DESCRIPTION OF THE DRAWINGS

Example embodiments are described in detail below with reference to the attached drawing figures, wherein:

FIGS. 1A-1D show various views of a conventional cell phone case;

FIGS. 2A-2D show various views of a conventional cell phone case with a conventional cell phone;

FIGS. 3A-3D illustrate an inventive phone case in accordance with example embodiments;

FIGS. 4A-4G illustrate the inventive phone case with a conventional cell phone;

FIG. 5 illustrates another inventive phone case in accordance with example embodiments;

FIGS. 6A-6B illustrate another inventive phone case in accordance with example embodiments;

FIG. 7 is a perspective view of a conventional cell phone;

FIGS. 8A-8B illustrate an inventive phone case in accordance with example embodiments;

FIGS. 9A-9D another inventive phone case in accordance with example embodiments;

FIG. 10 is a view of another inventive phone case in accordance with example embodiments (rack and pinion);

FIG. 11 is a view of another inventive phone case in accordance with example embodiments (light pipe);

FIG. 12 is a view of another inventive phone case in accordance with example embodiments (light pipes directing light to front side of phone around screen);

FIG. 13 is a view of an accessory in usable for focusing light emitted from a cell phone and/or filtering the light emitted from the cell phone in accordance with example embodiments;

FIG. 14 is a front cross-section view of the accessory in accordance with example embodiments;

FIG. 15 is another front cross-section view of the accessory in accordance with example embodiments;

FIG. 16 is side cross-section view of the accessory in accordance with example embodiments;

FIG. 16B is side cross-section view of the accessory in accordance with example embodiments;

FIG. 17 is another side cross-section view of the accessory in accordance with example embodiments;

FIG. 18 is another side cross-section view of the accessory in accordance with example embodiments;

FIG. 19 is another side cross-section view of the accessory in accordance with example embodiments;

FIG. 20 is another side cross-section view of the accessory in accordance with example embodiments;

FIG. 21 is another side cross-section view of the accessory in accordance with example embodiments;

FIG. 22 is a view of an accessory in usable for focusing light emitted from a cell phone and/or filtering the light emitted from the cell phone in accordance with example embodiments;

FIG. 23 is a side cross-section view of the exemplary accessory;

FIG. 24 is a view of an accessory in usable for focusing light emitted from a cell phone and/or filtering the light emitted from the cell phone in accordance with example embodiments;

FIG. 25 is a perspective view of an accessory in accordance with example embodiments;

FIG. 26 is a perspective view of an accessory in accordance with example embodiments;

FIG. 27 is a perspective view of an accessory in accordance with example embodiments;

FIG. 28 is a perspective view of an accessory in accordance with example embodiments;

FIG. 29 is a view of a cell phone case with an accessory in accordance with example embodiments;

FIG. 30 is a view of an accessory in accordance with example embodiments;

FIG. 31 is a view of an accessory and cell phone case in accordance with example embodiments;

FIG. 32 is a partial side view of an accessory connected to a cell phone by an adhesive in accordance with example embodiments;

FIG. 33 is a view of an accessory in accordance with example embodiments;

FIG. 34 is a view of an accessory in accordance with example embodiments;

FIG. 35 is a view of an accessory in accordance with example embodiments;

FIG. 36 is a view of an accessory in accordance with example embodiments;

FIG. 37 is a top view a body of an accessory in accordance with example embodiments;

FIG. 38 is a side view a body of an accessory in accordance with example embodiments;

FIG. 39 is a bottom view a bottom of an accessory in accordance with example embodiments;

FIG. 40 is a perspective view of an accessory in accordance with example embodiments;

FIG. 41 is a view of an accessory in accordance with example embodiments;

FIG. 42 is a view of an accessory in accordance with example embodiments; and

FIG. 43 is a side view of an accessory mounted on a cell phone by an adhesive in accordance with example embodiments.

### DETAILED DESCRIPTION

Example embodiments will now be described more fully with reference to the accompanying drawings. Example embodiments are not intended to limit the disclosure since the disclosure may be embodied in different forms. Rather, example embodiments are provided so that this disclosure will be thorough and complete, and will fully convey the scope of the disclosure to those skilled in the art. In the drawings, the sizes of components may be exaggerated for clarity.

In this application, when a first element is described as being “on” or “connected to” a second element, the first element may be directly on or directly connected to the second element or may be on or connected to an intervening element that may be present between the first element and the second element. When a first element is described as being “directly on” or “directly connected to” a second element, there are no intervening elements. In this application, the term “and/or” includes any and all combinations of one or more of the associated listed items.

In this application, spatially relative terms merely describe one element's relationship to another. The spatially relative terms are intended to encompass different orientations of the structure. For example, if a first element of a structure is described as being “above” a second element, the term “above” is not meant to limit the disclosure since, if the structure is turned over, the first element would be “beneath” the second element. As such, use of the term “above” is intended to encompass the terms “above” and “below”. The structure may be otherwise oriented (rotated 90 degrees or at other orientations) and the spatially relative descriptors used herein interpreted accordingly.

Example embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Example embodiments relate to cell phone cases having lenses and/or color filters.

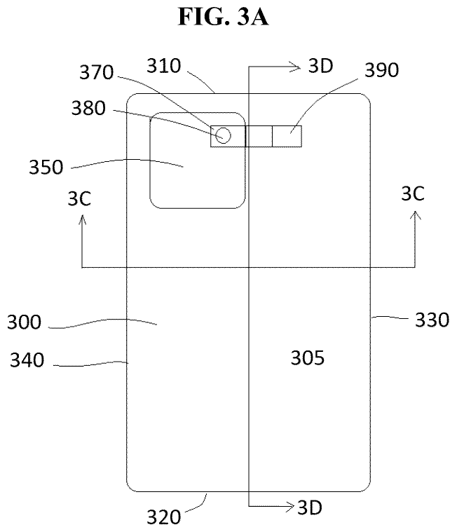

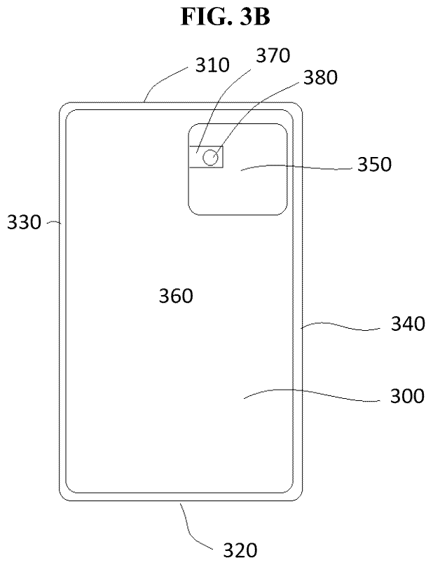

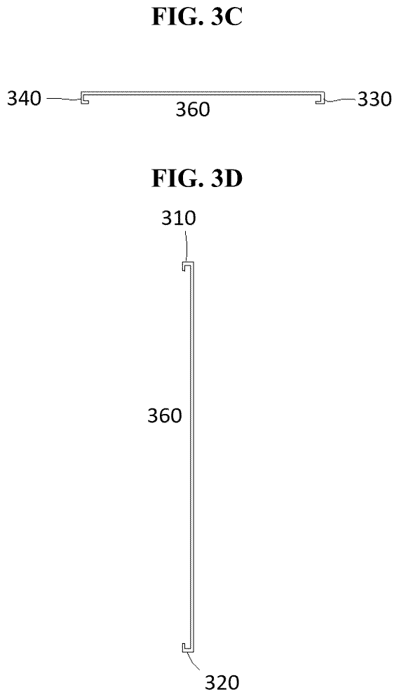

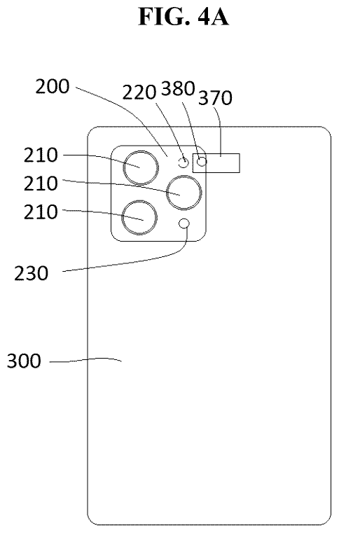

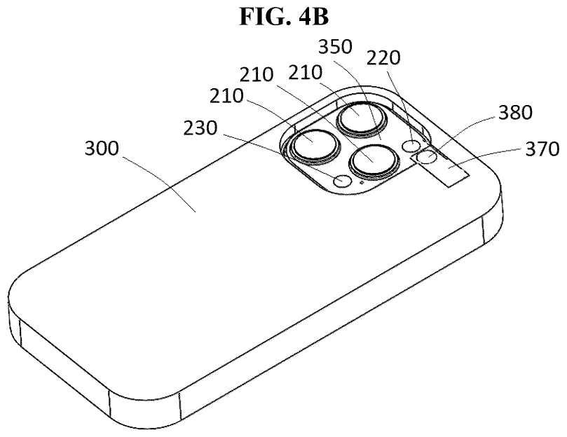

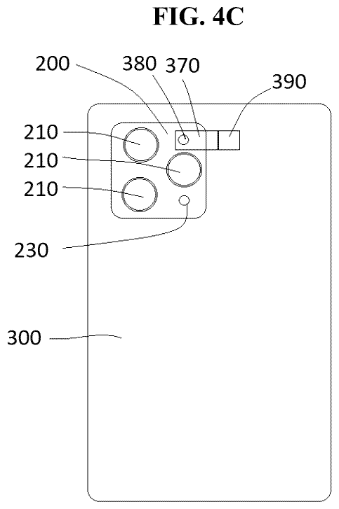

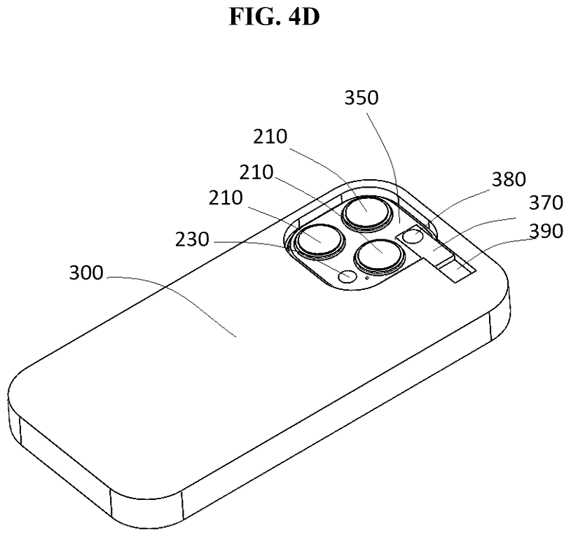

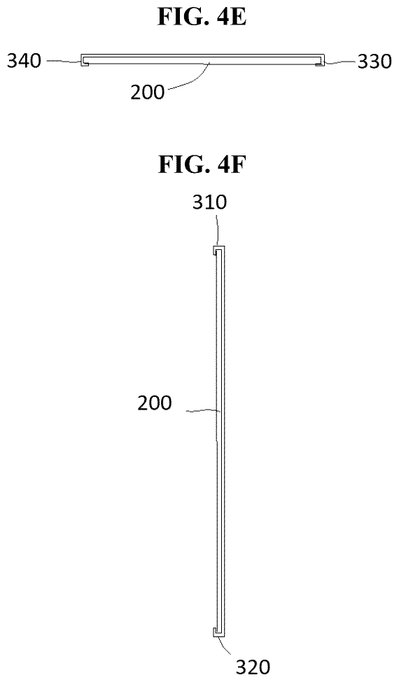

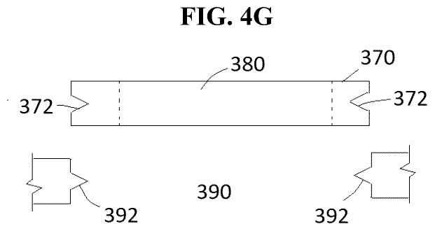

FIGS. 3A and 3B respectively show a front and back view of a cell phone case 300 in accordance with an example of the invention. As shown in FIGS. 3A and 3B the cell phone case 300 is somewhat rectangular in shape having a substantially continuous and planer front face 305 with a window 350. Like the conventional art, the cell phone case 300 has a top 310, a bottom 320, a first side 330 and a second side 340. As shown in FIGS. 3C and 3D, the top 310, the bottom 320, the first side 330, and the second side 340 include walls extending from the front face 305 which include lips forming a space 360 into which a cell phone 200 may be captured as shown in FIGS. 4E and 4F. In this nonlimiting example embodiment the cell phone case 300 may be made from materials such as, but not limited to, plastic, leather, carbon fibers and/or aramid fibers. Thus, the cell phone case 300 may be somewhat resilient allowing a flexure of the cell phone case 300 to capture the cell phone 200 in the space 360.

Unlike the prior art, the cell phone case 300 of example embodiments includes a lens switcher configured to present a lens and/or a color filter to a captured cell phone 200. In one nonlimiting example embodiment the lens switcher is comprised of a movable element 370 having a lens (or color filter) 380 which may be arranged over the light 220 of a conventional cell phone 200. In this nonlimiting example embodiment the cell phone case 300 includes a slot 390 which may retain the movable element 370 while allowing the moveable element 370 to translate along the slot 390 to one of cover and uncover the light 220 with the lens (or color filter) 380. For example, FIGS. 4A and 4B show the moveable element 370 in a first position such that the lens (or color filter) 380 is not over the light 220 whereas FIGS. 4C and 4D show the moveable element 370 in a second position where the lens (or color filter) 380 is placed over the light 220. Although one skilled in the art would readily recognize many ways the moveable element 370 may be retained in the slot 390 one way is to configure the movable element 370 to include indentations 372 which may correspond to rails 392 protruding into the slot 390 (see FIG. 4G). The rails 392 may fit within the indentations 372 to keep the movable element 370 from being removed from the phone case 100, while allowing back and forth movement of the moveable element 370 to position the lens (or color filter) 380 towards or away from the light 220. It should be known that this is one of many different slidable attachment methods known in the art and any other method that allows for the slidable movement necessary while holding the movable element 370 to the phone case 300 is within the scope of the disclosure, such as the reversal of the rails 392 and the slots indentations 372 onto the opposite parts.

In example embodiments the lens switcher provides certain features that are not present in conventional cell phone cases. For example, in example embodiments the lens 380 may be configured to focus light generated from the light 220 to better illuminate an object to be photographed. Further, rather than presenting a lens 380, the movable element 370 may instead cover the light 220 with a light filter, for example, a filter that only (or substantially only) allows red light (or blue light, magenta light, yellow light, etc.) to exit the cell phone case 300. This may provide a desirable effect for a user taking a picture or produce a light which is more desirable in low light situations like in a restaurant. Further, being able to switch the color of light being emitted from a cell phone case 300 may make it easier for the user to be spotted in a large crowd since the color of light emitted from the cell phone is distinguishable from other cell phones.

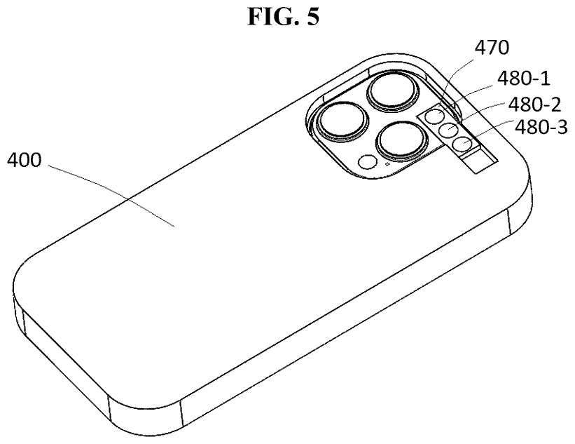

In the above example embodiment, the movable element 370 (which may be considered a slider) is configured to present a single lens (or a single color filter) 380 to a light 220 of the cell phone 200. However, this is not meant to limit the invention. For example, FIG. 5 illustrates another inventive cell phone case 400 which is substantially the same as the cell phone case 300, thus, a detailed description thereof will be omitted for the sake of brevity. However, as one skilled in the art would surely notice, the lens switcher of FIG. 5 includes a movable element 470 (which may be considered a slider) having multiple lenses (or color filters) 480-1, 480-2, and 480-3 which may be slide over the light 220 of the cell phone 200. This allows a user to utilize various lenses with various focal lengths to better control light directed at an object to be photographed. In the alternative, the movable element 470 may be configured to present various color filters to the light 220 so that the user can choose amongst a number of filters through which light from the light 220 will pass. This would allow a user to select, for example, a red filter when a low light condition is desired, or a blue light if the user would like to photograph a subject in blue light. Although the moveable element 470 of FIG. 5 is shown as having three lenses (or color filters) 480-1, 480-2, and 480-3, it could include only two or more than three lenses (or color filters) 480-1, 480-2, and 480-3. Further, as one skilled in the art would appreciate, not all of the 480-1, 480-2, and 480-3 are required to be lenses or color filters. For example, 480-1 could be a lens where 480-2 could be a color filter.

It is also understood that in some embodiments, interference elements may be attached to the movable element 470 and/or the case 400 to positively stop the moveable element 470 in a predetermined position and keep the movable element 470 in the desired position during use. The interference elements may be nibs, bosses, living hinges, clips, or any other elements known in the art to prevent unwanted movement of the movable element 470 and simultaneously allowing a user to move the movable element 470 when desired.

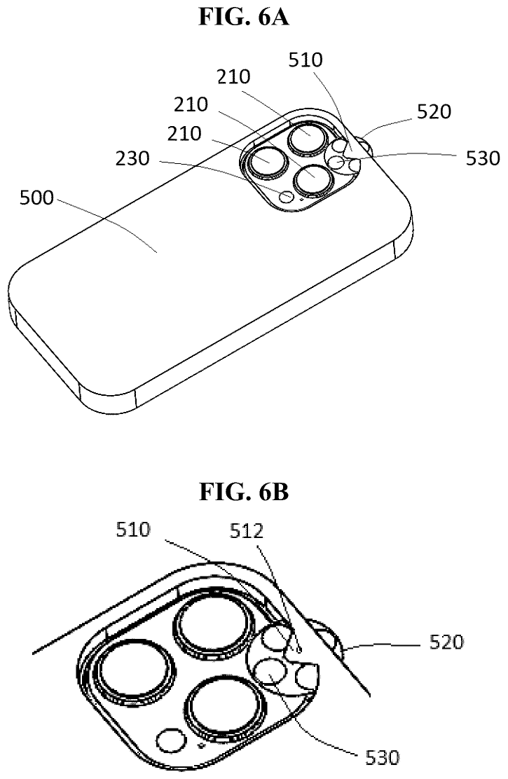

Although example embodiments, thus far, have described cell phone cases 300 and 400 that utilize a slider 370 and 470 to cover a cell phone light 220 with a color filter or lens 380 and 480, the invention is not limited thereto. For example, FIGS. 6A and 6B illustrate yet another example embodiment of a cell phone case 500 which may have one or more lenses or filters 530 to cover a cell phone light 220. Rather than configuring the lens switcher using a slider type arrangement, the embodiment of FIGS. 6A and 6B utilize a wheel type of lens switcher. That is, in the embodiment of FIGS. 6A and 6B the cell phone case 500 includes an extension portion 510 for attachment of a wheel 520 bearing one or more lenses (or color filters) 530 to attach to the cell phone case 500.

For example, in the nonlimiting example embodiment of FIGS. 6A and 6B a pin 512 may rotationally connect the wheel 520 to the case 500 and a user may simply rotate the wheel 520 to rotate a lens or color filter 530 over the light 220 of a cell phone 200. It is understood that while four lenses and/or color filters 530 are shown in FIGS. 6A and 6B, the wheel 520 may actually include less than four lenses and/or color filters 530 or more than four lenses and/or color filters.

It is also understood that in some embodiments, interference elements may be attached to the wheel 520 and/or the case 500 to positively stop the wheel in a predetermined position and keep the wheel 520 in the desired position during use. The interference elements may be nibs, bosses, living hinges, clips, or any other elements known in the art to prevent unwanted movement of the wheel 520 and simultaneously allowing a user to move the wheel 520 when desired.

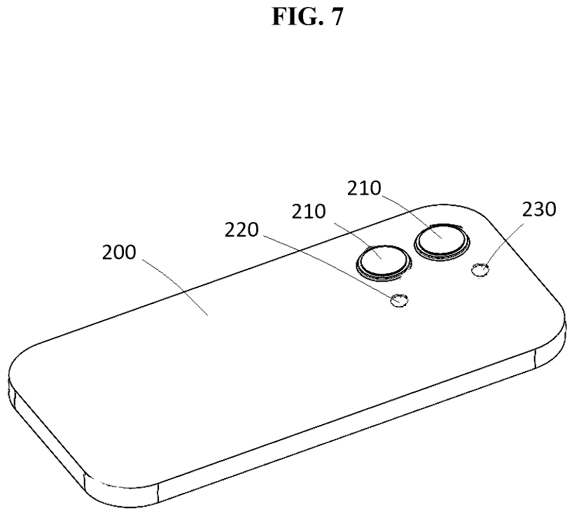

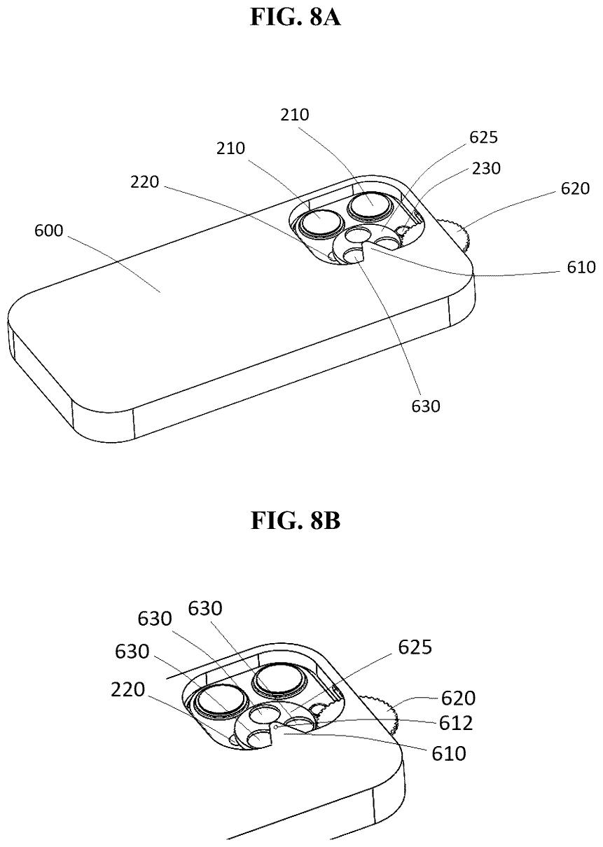

Thus far, the particular examples illustrated above show a cell phone 200 having three cameras 210, a light 220, and a LiDAR 230. The particular type of cell phone, of course, is not meant to limit the invention. For example, FIG. 7 illustrates another cell phone 200 having two cameras 210 (rather than three), a light 220 (for example, an LED light), and a LiDAR 230. In this type of camera, the light 220 offset distance from an edge of the camera 200 such that a lens presenter may require an intermediary member. To this end, cell phone case 600 is designed to protect the cell phone 200 while still allowing for a lens and/or color filter 630 to be placed over the light 220. In this particular nonlimiting example, a cell phone case 600 includes a window to expose the cameras 210, light 220, and LiDAR 230. However, in this case because the light 220 is somewhat remote from an edge of the cell phone, a compound lens and/or color filter presenter is used to present a lens and/or color filter 630 over the light 220. In this nonlimiting example embodiment, the compound lens and/or color filter presenter is comprised of a first wheel 620 arranged near an end of the cell phone case 600. The first wheel 620 may engage a second wheel 625 which has one or more lenses and/or color filters 630. In this nonlimiting example embodiment a user may rotate the first wheel 620 which thereby rotates the second wheel 625 to place the one or more lenses and/or color filters 630 over the light 220. As one skilled in the art would readily appreciate, the first and second wheels 620 and 625 may be fixed in the cell phone case 600 in a manner that allows them to rotate. For example, the cell phone case 600 may include an extension portion 610 which may provide a pin 612 which penetrates the second wheel 620 to keep the second wheel 620 in place while allowing the second wheel 620 to rotate. The first wheel 620 may be similarly supported.

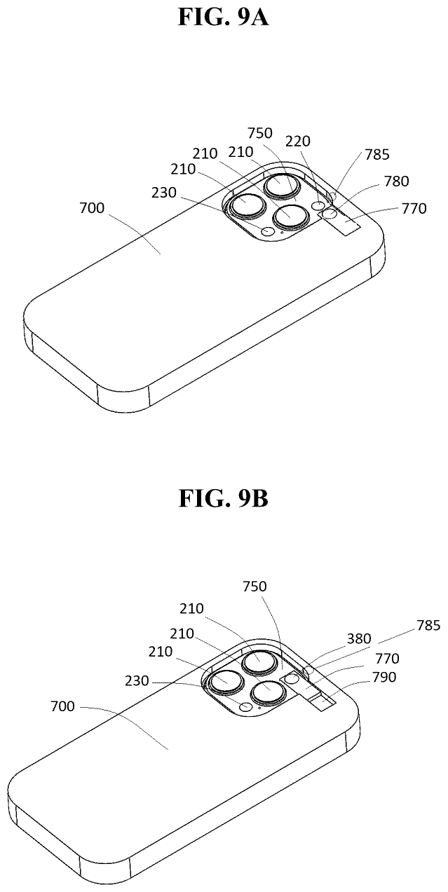

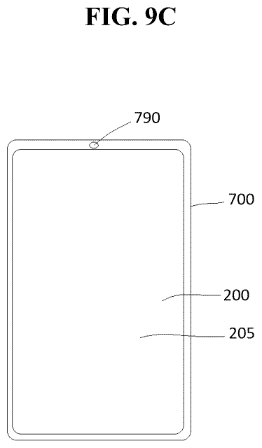

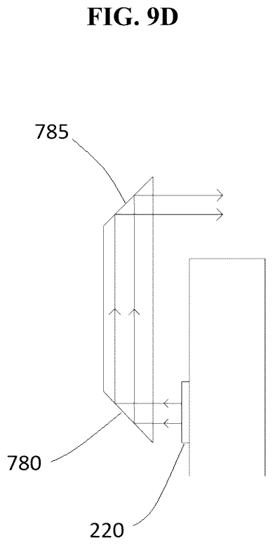

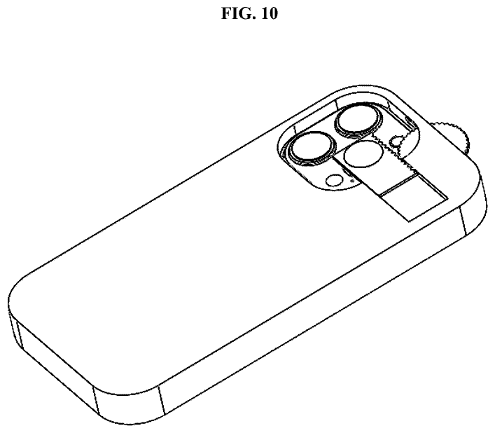

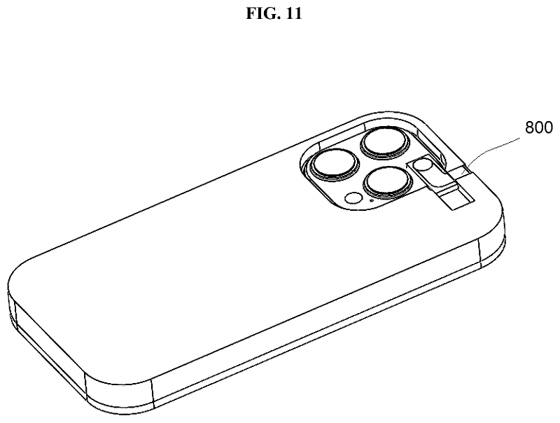

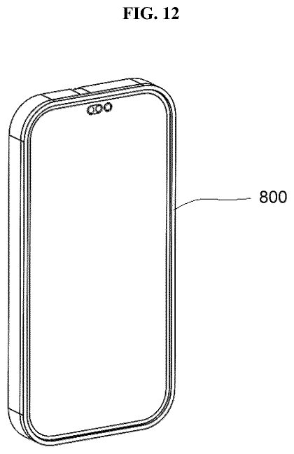

Example embodiments illustrate cases for cell phones which greatly increase the functionality of the cell phone by placing a lens and/or filter over the cell phone's light. However, the inventive concepts are not limited thereto. For example, in addition to presenting a lens and/or color filter to the cell phone's light, the cell phone case may be adapted to present a mirror 780 to the cell phone's light to funnel light from the back of the cell phone to the front of the cell phone. For example, Unlike the prior art, the cell phone case 700 of example embodiments includes a mirror presenter configured to present a mirror 780 to a captured cell phone 200. In one nonlimiting example embodiment the mirror presenter is comprised of a movable element 770 having mirror 780 which may be arranged over the light 220 of a conventional cell phone 200 as shown in FIG. 9B. In this nonlimiting example embodiment the cell phone case 700 includes a slot 790 which may retain the movable element 770 while allowing the moveable element 770 to translate along the slot 790 to one of cover and uncover the light 220 with the mirror 780. For example, FIG. 9A shows the moveable element 770 in a first position such that the mirror 780 is not over the light 220 whereas FIG. 9B shows the moveable element 770 in a second position where the mirror 780 is placed over the light 220. FIG. 9A, as mentioned above, shows an exemplary cell phone case 700 having the slider element 770 configured to present a mirror 780 over the light 220. When the slider element 770 is slid forward the mirror 780 may direct light to the towards a second mirror 785 which may direct light out of an opening 790 at a front of the cell phone case 700 as shown in FIG. 9C. Schematically, this embodiment is represented in FIG. 9D. A particular advantage of this nonlimiting example embodiment is the light 220 may now be used to illuminate a subject who wishes to view the interface 205 while taking a selfie.

Although FIGS. 9A-9D illustrate directing light from the light 220 out to an opening 790 at a front of the cell phone case 700, there are many variations of this embodiment. For example, the mirror 780 may reflect light to light pipes 800 which may be arranged throughout the cell phone case to illuminate the cell phone case. Furthermore, for example, light pipes may be arranged so that the perimeter of the interface 205 is illuminated to provide a softer illumination.

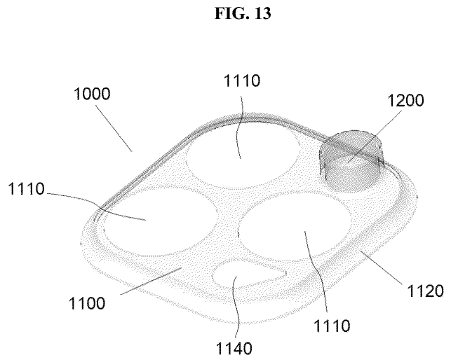

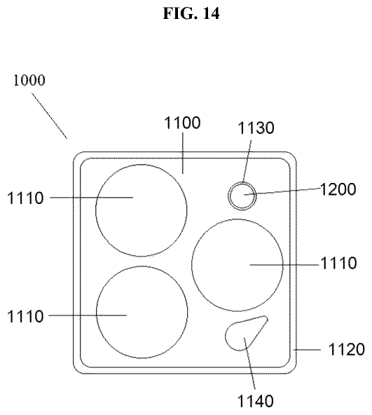

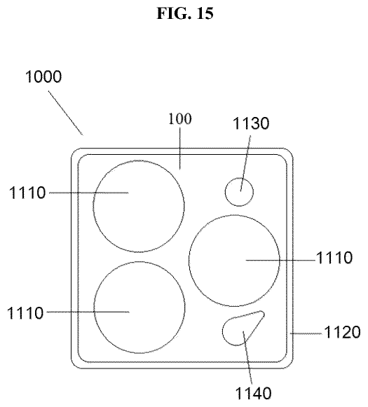

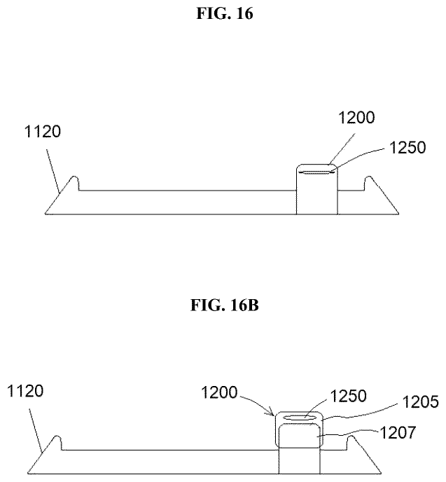

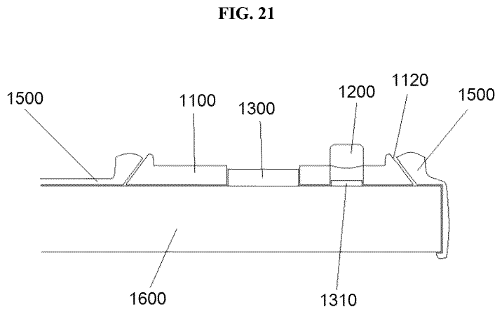

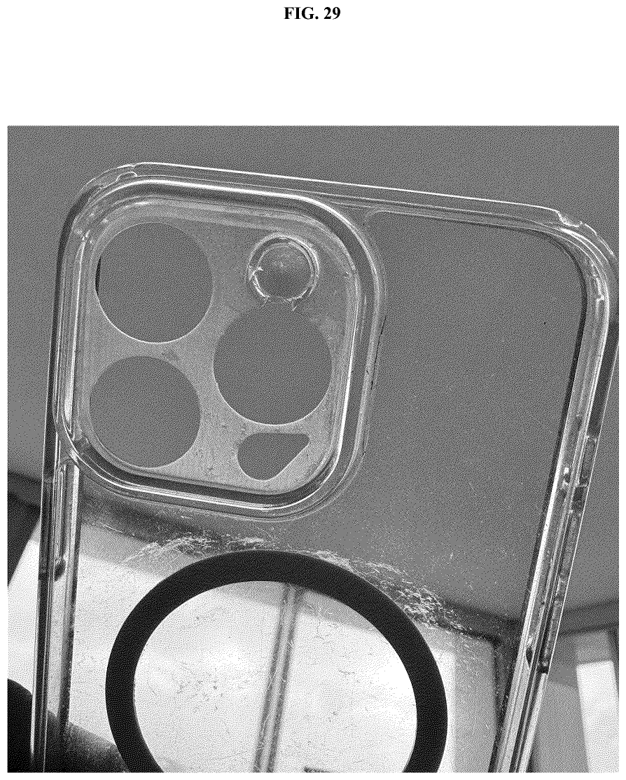

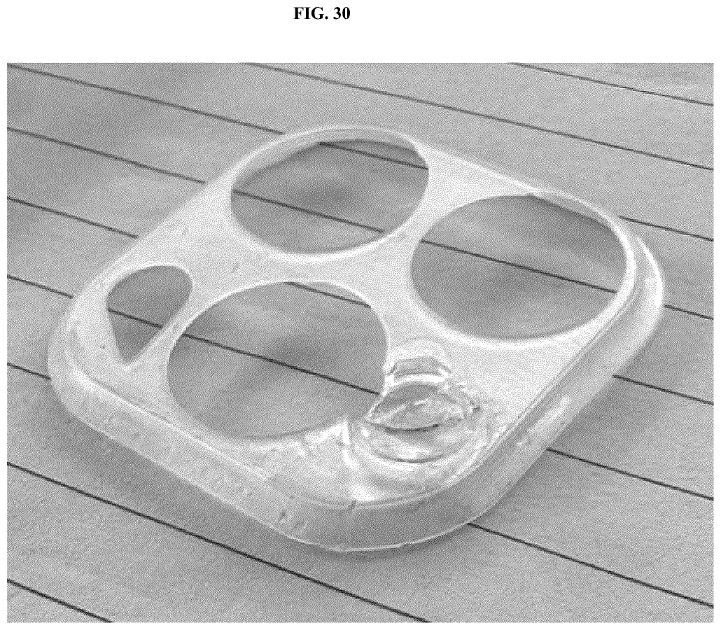

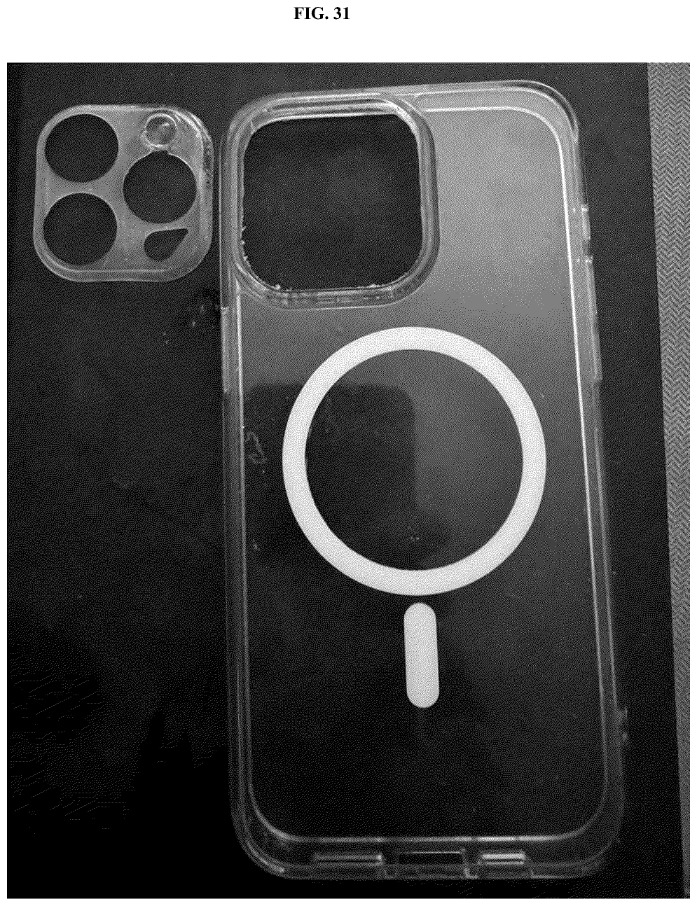

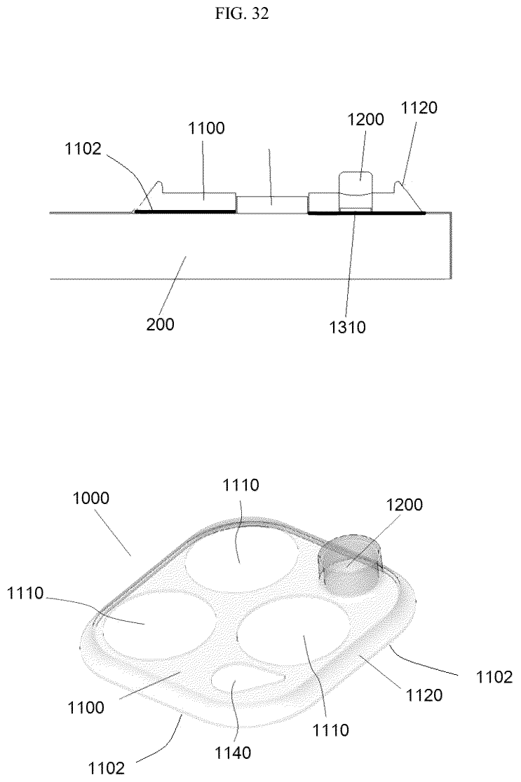

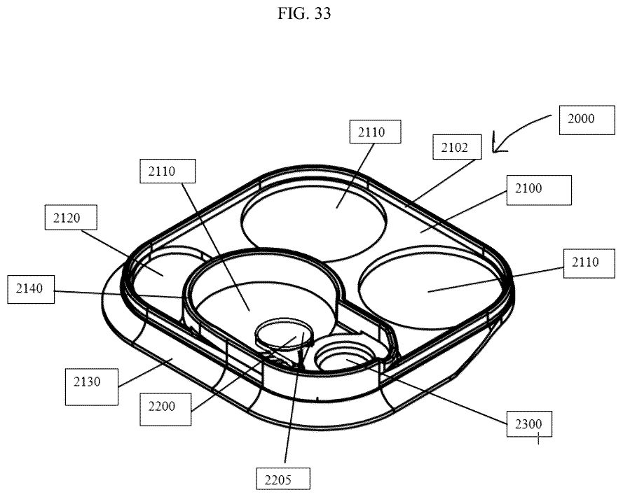

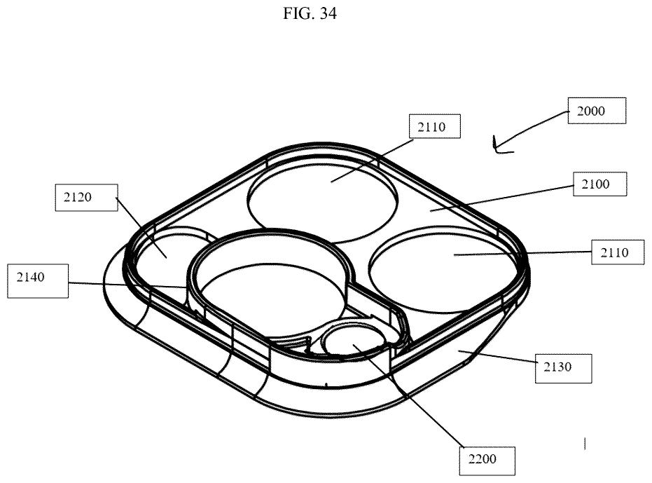

FIG. 13 is a perspective view of an accessory 1000 usable for varying a width and/or color of a light emitted by a light 220 a cell phone 200. Referring to FIGS. 13-21 and 29-31, the accessory 1000 according to a nonlimiting example embodiment is comprised of a housing 1100 and an optical assembly 1200. FIGS. 14 and 15 are front cross section views of the accessory 1000. FIGS. 16-21 are side cross section views of the accessory 1000 in accordance with example nonlimiting embodiments. FIGS. 29-31 are perspective views of the accessory 1000 shown as used in connection with a cell phone case 100.

Referring to FIG. 13, the housing 1100 of the accessory 1000 may include at least one opening 1110 to accommodate and/or expose at least one camera 210 of a cell phone 200. It is understood the cell phone 200 described herein is merely for the purpose of illustration as conventional cell phones vary from one embodiment to another. For example, as previously explained, some cell phones include only a single camera while others have two cameras while others may have three or more cameras. Furthermore, the arrangement of the cameras 210 may vary from one cell phone to another. Therefore, the housing 1100 may have as many openings 1110 as necessary, arranged in whichever pattern as necessary, to accommodate various cell phone 200 embodiments. The openings 1110 are provided so the housing 1100 may not obstruct the view of the cameras 210 when taking photographs or video recordings. In accordance with example embodiments, the housing 1100 may include at least one sensor opening 1140 to accommodate sensors 230 on cell phones 200. The sensor openings 1140 are provided so that the housing 1100 may not obstruct the sensor 230 and limit the functionality of the sensor 230. In accordance with example embodiments, the housing 1100 may include at least one opening 1130 to accommodate and/or expose a light 220 of a cell phone 200. The opening 1130 is provided so that the housing 1100 may allow the emitted light from light 220 to pass through an optical assembly 1200. While example embodiments illustrate the housing as having several openings (1110, 1140, and 1130) it is understood that openings are not a strict necessity since the regions corresponding the openings may be occupied by a relatively transparent material which may not interfere use of the aforementioned cameras 220, light 210, and sensor 230.

Further referring to FIG. 13, the accessory 1000 may include the optical assembly 1200 operably and/or directly and/or indirectly connected to the housing 1100. The optical assembly 1200 may be fixed in one position within the housing 1100, suspended over the light 220 of the cell phone 200. The optical assembly 1130 may be configured to extend to and/or through the opening 1130 of the housing 1100. The optical assembly 1200 may include a lens and/or color filter 1250 that may be movable within the optical assembly 1200. The optical assembly 1200 may be configured to focus a beam of a light 1310 of a cell phone 200 and/or change it's color. Movement of the lens and/or color filter 1250 within the optical assembly 200 further away from or closer to the light 310 may adjust the width of the beam of the light 310 and/or allow only certain colors to escape the housing 1100. In example embodiments, the lens and/or color filter 1250 may be threaded within the optical assembly 1200, so the position of the lens and/or color filter 1250 may be changed by rotating the lens and/or color filter 1250 within the optical assembly 1200. For example, as shown in FIG. 16B, the optical assembly many include a cylindrical stem 1207 which extends through the housing 1100 and a cylindrical cap 1205 threadingly engaged with the cylindrical stem 1207. In this nonlimiting example embodiment the lens and/or color filter 1250 may be fixed in the cap 1205 so that as the cap 1205 is rotated with respect to the stem 1207 the lens 1250 moves closer to or away from the light 220 (depending on the direction the cap 1250 is turned) to allow the beam of light generated by the light 220 to narrow or widen. In the alternative, the cap 1205 and the stem 1207 may be telescopingly engaged with one another so all a user must do is to push down or pull up the cap to adjust the light emitted from the cell phone's light 220.

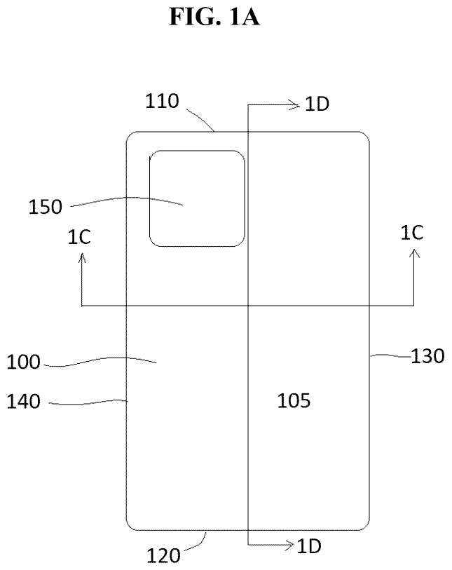

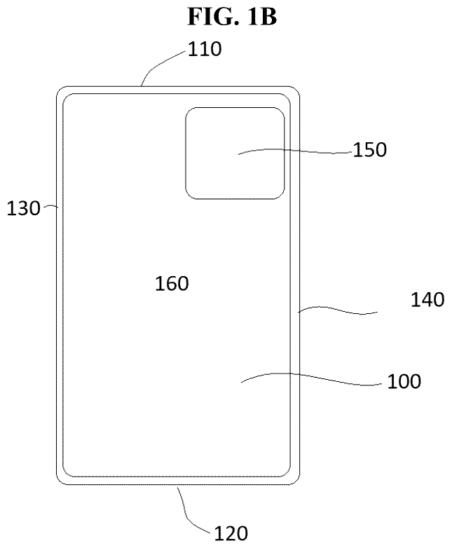

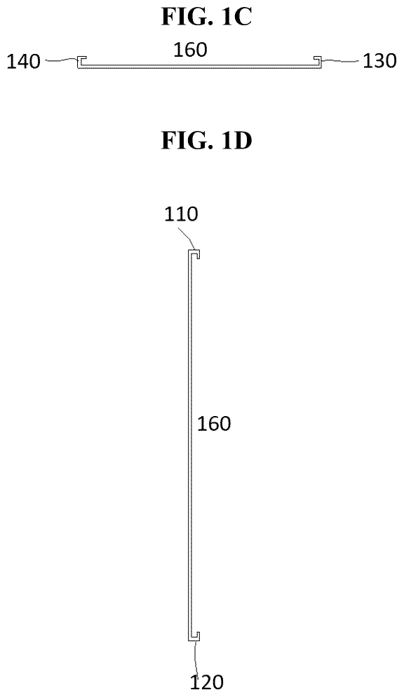

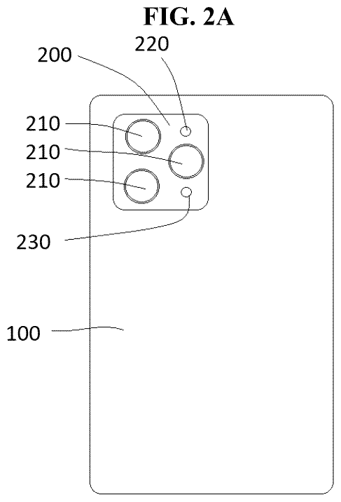

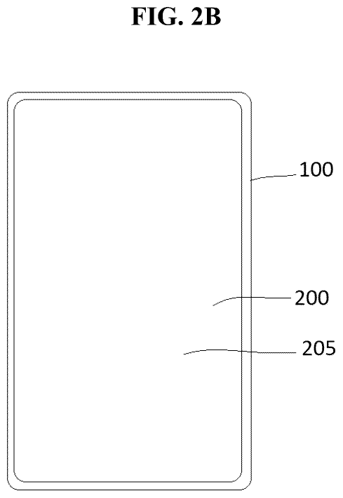

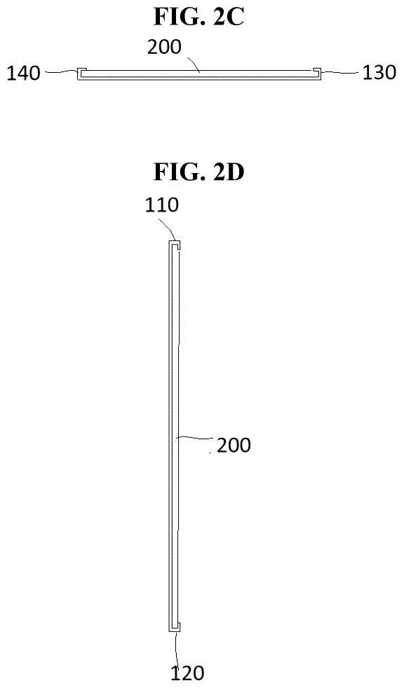

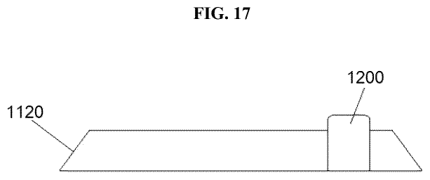

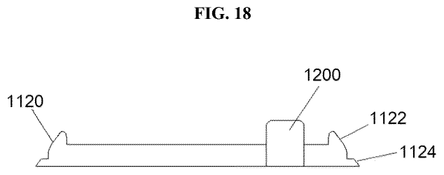

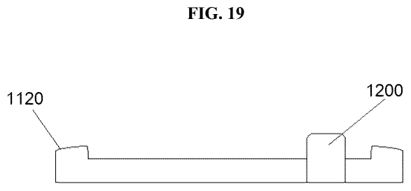

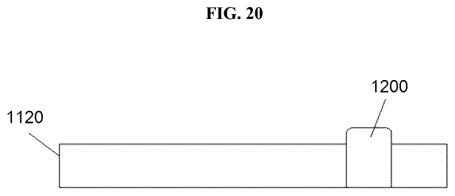

The housing 1100 of the accessory 1000 may include edges 1120. In example embodiments, the edges 1120 of the housing 1100 may hold the accessory 1000 in place within a window 150 of a cell phone case 100 (see FIG. 1A). The window 150 of a cell phone case 100 may overlap the edges 1120 of the housing 1100 to hold the accessory 1000 in position above the lens mound of the cell phone 200. The edges 1120 may continue to raise above the front face 1105 of the housing 1100 to provide support and protection for the cameras 210 and the optical assembly 1200 (see FIGS. 16, 18, 19, and 21). To fit within the window 150 of the cell phone case 100, the edges 1120 of the housing 1100 may be tapered (see FIGS. 16-17), staged (see FIG. 18), rounded (see FIG. 19), or squared (see FIG. 20), as an example of a few nonlimiting embodiments.

In example embodiments, the accessory 1000 may be cell in place by the cell phone case 100 as described above, however, this is not the only means of associating the accessory 1000 with the cell phone case 100. For example, rather than forming the accessory 1000 with edges 1120 which act to trap the accessory 1000, the accessory 1000 may be placed over the window and secured in place using an adhesive 1102 which may be placed between the edges 1120 of the accessory 1000 and the cell phone case 100. In fact, this means may also be used to secure the accessory 1000 to a cell phone 200 when a cell phone case 100 is not used to protect the cell phone 200.

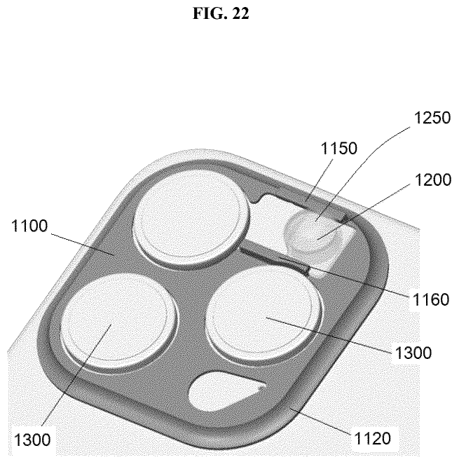

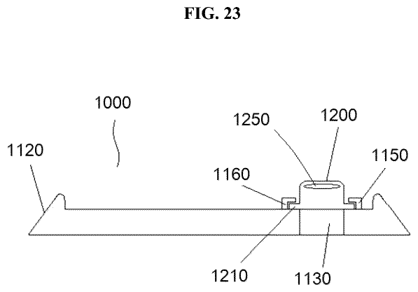

FIG. 22 is a view of another exemplary accessory 1000 usable for varying a width of a light generated by the light 210 of a cell phone 200. Referring to FIGS. 22 and 23, the accessory 1000 according to a nonlimiting example embodiment is comprised of a housing 1100 and an optical assembly 1200. FIG. 23 is a side cross section view of the handheld device light accessory 1000 in accordance with an example nonlimiting embodiment.

Referring to FIG. 22, the accessory 1000 may include an optical assembly 1200 which may be operably connected to a housing 1100 and/or directly and/or indirectly connected to the housing 1100. In this example embodiment, the housing 1100 may include an upper rail 1150 and a lower rail 1160. The upper rail 1150 and the lower rail 1160 may combine to form a track 1170. The upper rail 1150 may be placed above the optical assembly opening 1130 and the lower rail 1160 may be placed below the optical assembly opening 1130, forming the track 1170 across the light 220 of the cell phone 200. The upper rail 1150 and lower rail 1160 may consist of opposite facing L-shaped members to form the track 1170 (see FIG. 23).

Referring to FIGS. 22 and 23, in accordance with an example nonlimiting embodiment, the optical assembly 1200 may include an optical assembly support 1210. The optical assembly support 1210 may be operably connected to the housing 1100 of the accessory 1000. The optical assembly support 1210 may be in the shape of a square, rectangle, cube, or brick attached to a base 1202 of the optical assembly 1200. The optical assembly support 1210 may slide back and forth within the track 1170, which is comprised of the upper rail 1150 and the lower rail 1160 of the housing 1100. The optical assembly 1200 may be positioned within the track 1170 out of the path of the light emitted from the light 220 of the cell phone 200, allowing an unobstructed path for the light to illuminate as it normally does on a conventional cell phone 200. Alternatively, the optical assembly 1200 may be positioned within the track 170 in the path of the light emitted from light 220 of the cell phone 200, allowing for the width and/or color of the beam of the light to be varied by a lens and/or color filter 1250 contained within the optical assembly 1200. In example embodiments, the position of the lens and/or color filter 1250 with respect to the light 220 may be able to be varied to permit a user to set a desired width of the beam and/or color of light emitted by light 220.

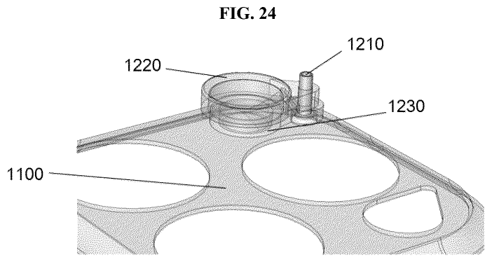

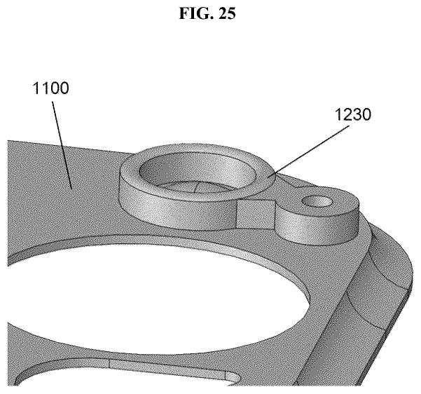

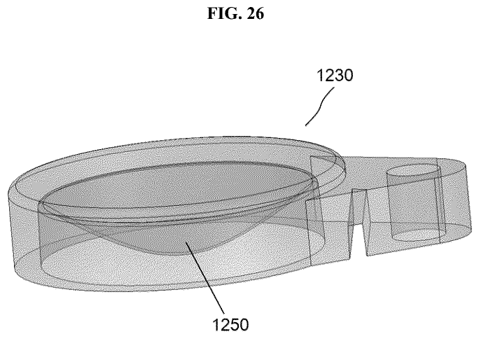

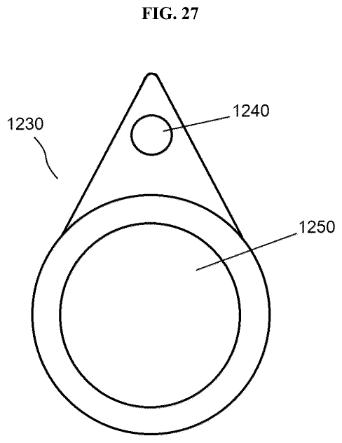

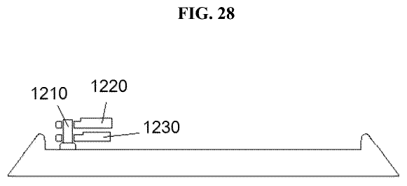

FIG. 24 is yet another example embodiment of an accessory 1000 usable for varying a width or changing a color of light emitted by a light 220 of a cell phone 200. Referring to FIGS. 24-28, the accessory 1000 according to a nonlimiting example embodiment is comprised of a housing 1100 and an optical assembly 1200. FIG. 25 is a perspective view of a portion of the housing 1100 which may comprise a bottom assembly 1230 of the optical assembly 1200 of the accessory 1000 in accordance with an example nonlimiting embodiment. FIG. 26 is a perspective view of a top optical assembly 1220 or a bottom optical assembly 1230 in accordance with an example nonlimiting embodiment. FIG. 27 is a top cross section view of a top optical assembly 1220 or a bottom optical assembly 1230 in accordance with an example nonlimiting embodiment. FIG. 28 is a side cross section view of a handheld device light accessory 1000 in accordance with an example nonlimiting embodiment.

Referring to FIG. 24, the light accessory 1000 may include an optical assembly 1200 which is operably connected to a housing 1100. In this example embodiment, the housing 1100 may be connected to an optical assembly support 1210 in the form of a pin or a cylinder extending out perpendicularly from the front face 1105 of the housing 1100. The optical assembly support 1210 may be placed next to the optical assembly opening 1130 so that the optical assembly 1200 may be suspended over a light 220 of a cell phone 200. The optical assembly support 1210 may be configured to be rotatably connected to the optical assembly 1200.

Further referring to FIG. 24, in accordance with an example nonlimiting embodiment, the optical assembly 1200 may be comprised of a top optical assembly 1220 and a bottom optical assembly 1230. The bottom optical assembly 1230 may be located closest to the light 220 of the cell phone 200, and the top optical assembly 1220 may be located furthest from the light 220 of the cell phone 200. The bottom optical assembly 1230 and the top optical assembly 1220 may be rotatably attached to the optical assembly support 1210 so that they may freely rotate around the optical assembly support 1210. With the top optical assembly 1220 and the bottom optical assembly 1230 being rotatably attached to the optical assembly support 1210, they may be moved independently of each other to a position in front of the light 220 or a position out of the path of light from the light 220. In example embodiments, when the bottom optical assembly 1230 is placed in the path of the light 1310, the beam of the light from the light 220 is varied to a first width and/or the color is filtered. When the top optical assembly 1200 is placed in the path of the light from the light 220, the beam of the light 1310 is varied to a second width and/or may be changed to a second color. Finally, when both the bottom optical assembly 1230 and the top optical assembly 1220 are placed simultaneously in front of light emitted from light 220 of the cell phone 200, the beam of the light 1310 may be varied to a third width and/or filtered to a third color. The first, second, and third widths and first, second, and third colors may be adjusted as desired by inserting different types of lenses and/or color filters 1250 into the top optical assembly 1220 and the bottom optical assembly 1230. Referring to FIG. 25, in accordance with an example nonlimiting embodiment, the bottom optical assembly 1230 may be fixed to the housing 1100. In this example embodiment, only the top optical assembly 1220 would be freely rotatable around the optical assembly support 1210, while the bottom optical assembly 230 would always be positioned in the path of light emitted from light 220.

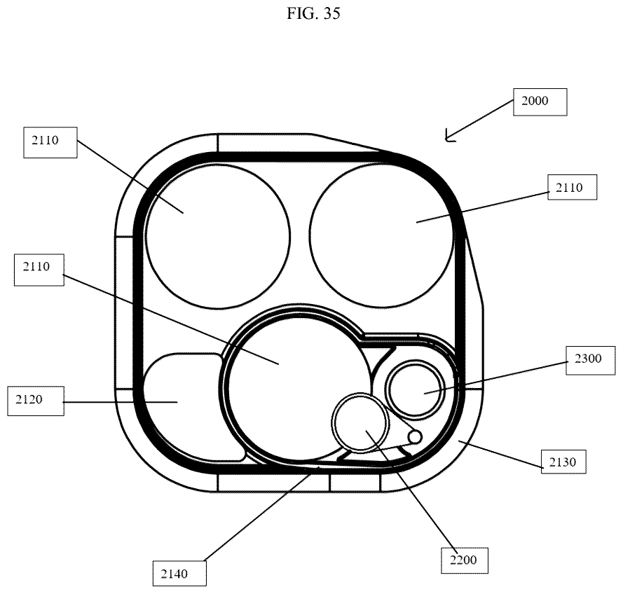

FIGS. 33-36 illustrate yet another example of an accessory 2000 usable to modify light emitted from a light of a conventional cell phone. As shown in FIGS. 33-36, the accessory 2000 may include a body 2100 and an actuator 2200, which, in FIGS. 33-36, are in the form of a swing arm. The body 2100 may include a substantially flat base having apertures configured to align with cameras and sensors of a conventional cell phone. In the example of FIGS. 33-36 three apertures 2110 are provided to accommodate three cameras of a conventional cell phone and one aperture 2120 is provided to accommodate a sensor, for example, LiDAR, of a conventional camera. The apertures may allow the cameras and sensors to operate in an unobstructed manner. However, it is understood that rather than providing apertures a clear material, for example, glass and/or plastic, may be provided in the regions corresponding to the apertures 2110 and 2120 to protect the cameras and sensors while still allowing them to operate efficiently and as expected. Though it is understood the particular example of FIGS. 33-36 show a body 2100 with three apertures 2120 to accommodate three cameras of a cell phone, because cell phones often have different numbers of cameras, as well as a different arrangement of cameras, the number and arrangement of apertures 2110 shown in FIGS. 33-36 is not critical.

As shown in FIGS. 33-36 the body 2100 may include an outer surface 2130 configured to be captured between a cell phone case and a cell phone as in the previous examples. For example, in one nonlimiting example embodiment, the accessory 2000 may be placed in the window of a conventional cell phone case such that the apertures 2110 align with the cameras of a cell phone and the aperture 2120 aligns with a sensor of a cell phone.

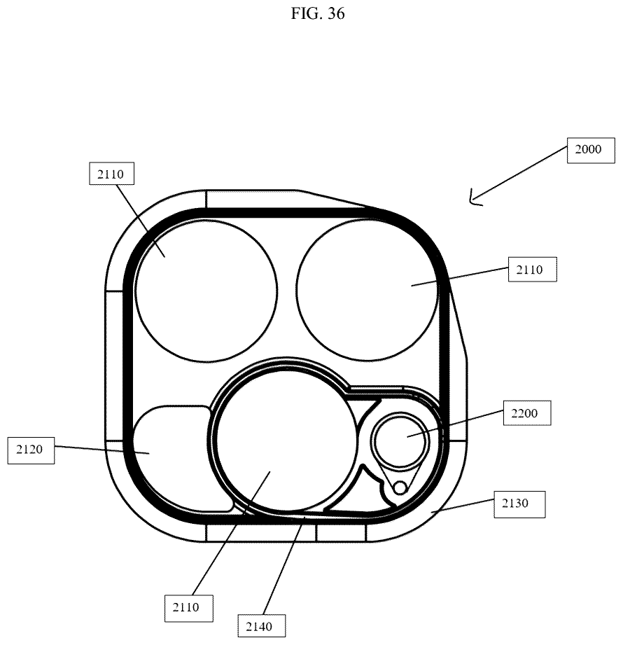

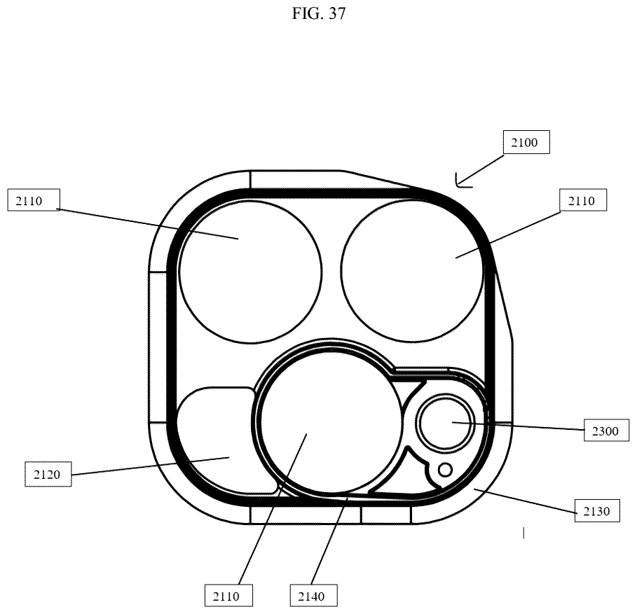

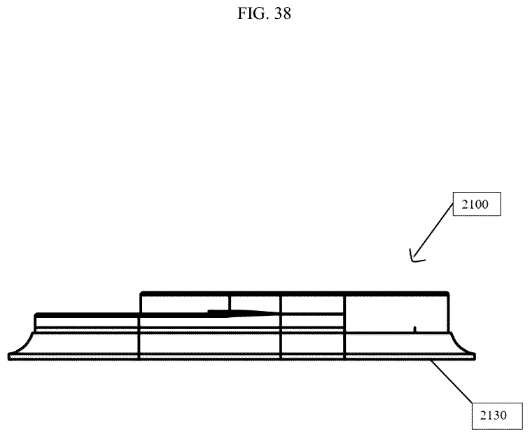

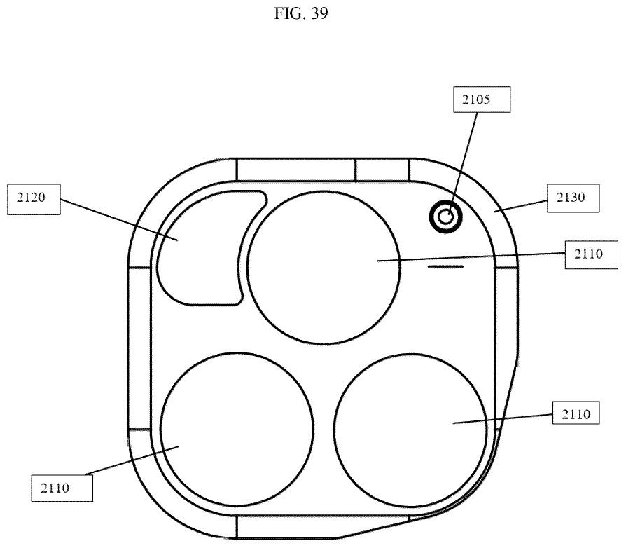

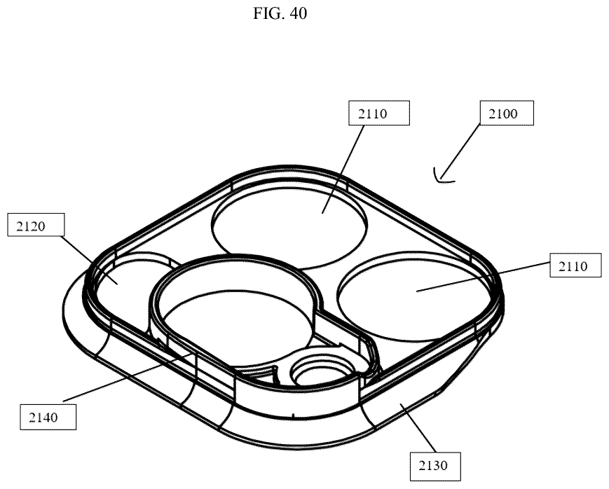

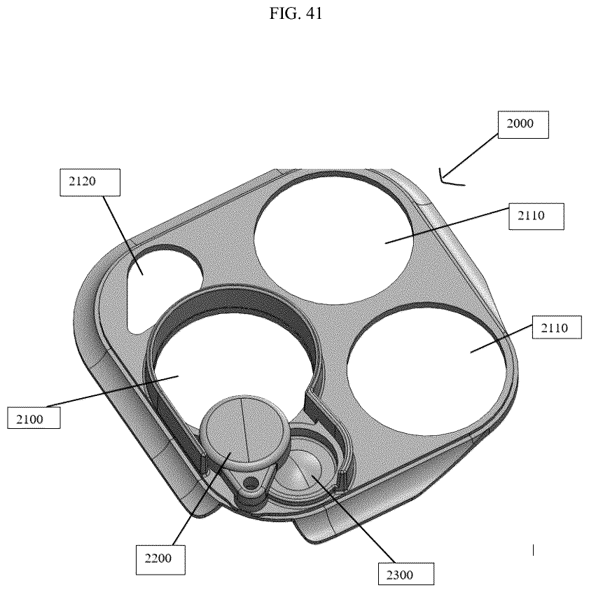

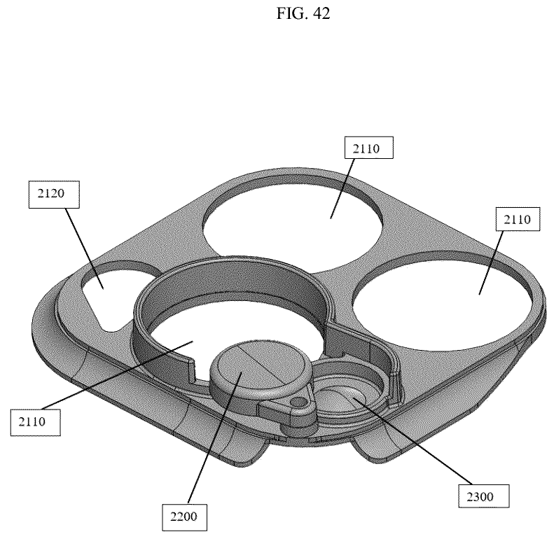

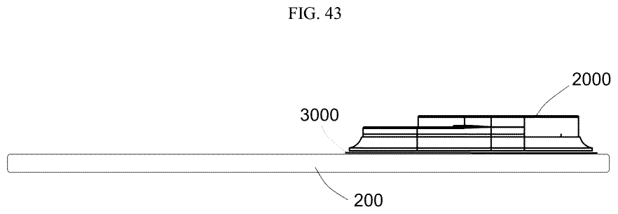

In example embodiments, the body 2100 may include an aperture 2105 (see FIG. 35) alignable with a light of a cell phone camera. The aperture may allow light to pass through the body 2100. More specifically, the body 2100 may include a first lens and or color filter 2300 (examples of a light modification elements) above the aperture 2105 so that when light is emitted from a cell phone the light passes through the aperture 2105 and through first lens and/or color filter 2300. In the event light modification element 2300 is a lens is formed in the body 2100 the lens 2300 may either be a converging lens or a diverging lens. A converging lens may allow for a brighter more focused concentration of light whereas the diverging lens may allow for light to be dispersed more broadly. The lens 2300 of course may be colored so as to control not only how the light is focused, but the color of light which passes through the lens 2300. For example, a user may desire a focused beam of red light. In this case, the lens 2300 may be designed as a converging lens that filters out all but red light. Of course, light modification element 2300, rather than being a lens, may be a color filter allowing only a certain color of light to pass through rather than focusing the light as is typical with a lens.

In example embodiments, the actuator 2200 may be fitted with a lens and/or color filter 2205 (another example of a light modification element) which may be swung over the lens and/or color filter 2300 (another example of a light modification element). In FIGS. 33, for example, the actuator 2200 is shown swung out of the way of light passing through the lens and/or color filter 2300 whereas FIG. 34 shows the swing arm 2200 swung over lens and/or color filter 2300 to further modify the light passing through the lens and/or color filter 2300. For example, in one embodiment, 2300 may be converging lens whereas the lens and/or color filter 2205 is a red filter. In this case, the 2300 may focus the light emitted from a light of a cell phone and 2400 allows only for red light to pass through the accessory 2000.

In example embodiments, the accessory 2000 may include a perimeter wall 2101 which substantially surrounds the body 2100 which may allow for some protection of the cell phone camera components. The accessory 2000 may also include a second wall 2140 which may surround and protect the swing arm 2200. In the embodiment shown in FIGS. 33-34 the second wall 2140 surrounds one of the apertures 2110 to prevent obstruction of the camera of the cell phone.

In example embodiments the accessory 2000 may be configured to be captured in an window of cell phone case as previously described. However, the accessory 2000 may be attached to directly a cell phone directly by via an adhesive 3000 such as a glue and/or tape.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described

What is claimed:

1. An accessory for a cell phone comprising:
a body having a first aperture alignable with a camera of the cell phone and a second aperture alignable with a light of the cell phone;
a first light modification element configured to receive light from the cell phone via the second aperture; and
an actuator having a second light modification element, the actuator being configured to move the second light modification element to a first position to modify light from the first light modification element and to a second position where the light from the first light modification element is not modified by the second light modification element.

2. The accessory of claim 1, wherein the actuator is a swing arm.

3. The accessory of claim 1, wherein the first light modification element is one of a lens and a color filter.

4. The accessory of claim 1, wherein the second light modification element is one of a lens and a color filter.

5. The accessory of claim 1, wherein the first light modification element is one of a colored diverging lens and a colored converging lens.

6. The accessory of claim 1, wherein the second light modification element is one of a colored diverging lens and a colored converging lens.

7. The accessory of claim 1, wherein the actuator is a swing arm.

8. The accessory of claim 1, wherein the body further includes a protective wall configured to protect the actuator.

9. The accessory of claim 1, wherein the body includes a protective wall around its perimeter.

10. A system comprising:
a cell phone having a light and a camera;
a cell phone case having a window that exposes the cameral and light of the cell phone; and
an accessory comprising a body having a first aperture aligned with the camera of the cell phone and a second aperture aligned with the light of the cellphone, the accessory having a first light modification element configured to receive and modify light from the cell phone via the second aperture, and an actuator having a second light modification element configured to receive and modify light from the first light modification element, the actuator being configured to move the second light modification element to a first position to modify the light from the first light modification element and to a second position where the light from the first light modification element is not modified by the second light modification element.

11. The system of claim 10, wherein a perimeter of the accessory is captured between the cell phone case and the cell phone.

12. The accessory of claim 10, wherein the actuator is a swing arm.

13. The accessory of claim 10, wherein the first light modification element is one of a lens and a color filter.

14. The accessory of claim 10, wherein the second light modification element is one of a lens and a color filter.

15. The accessory of claim 10, wherein the first light modification element is one of a colored diverging lens and a colored converging lens.

16. The accessory of claim 10, wherein the second light modification element is one of a colored diverging lens and a colored converging lens.

17. The accessory of claim 10, wherein the actuator is a swing arm.

18. The accessory of claim 10, wherein the body further includes a protective wall configured to protect the actuator.

19. The accessory of claim 10, wherein the body includes a protective wall around its perimeter.
